(19) United States
(12) Patent Application Publication
(10) Pub. No.: US 2022/0292550 A1
(43) Pub. Date: Sep. 15, 2022

(54) Apparatuses, Systems, and Methods for Providing an Automated Valuation Model for Commercial Real Estate

(71) Applicant: Green Street Advisors, LLC, Newport Beach, CA (US)

(72) Inventors: Andrew McCulloch, Irvine, CA (US); Robert Norman Filley, Newport Beach, CA (US); Daniel Wijaya, Irvine, CA (US); Dmitry Nikalaichyk, Irvine, CA (US); Otto Karl Aletter, Newport Beach, CA (US); Wilkie W. Ma, Irvine, CA (US)

(21) Appl. No.: 17/686,002

(22) Filed: Mar. 3, 2022

Related U.S. Application Data
(60) Provisional application No. 63/159,979, filed on Mar. 11, 2021.

(51) Int. Cl. G06Q 30/02; G06Q 50/16

(52) U.S. Cl. CPC G06Q 30/0278; G06Q 50/16

(57) ABSTRACT

Apparatuses, systems, and methods provide an Automated Valuation Model (AVM). The AVM includes one or more operations including providing a portal coupleable to a network interface, obtaining a plurality of valuations associated with a subject property via the portal, receiving at least one weighting factor associated with one or more of the plurality of valuations from a user via the portal, applying the least one weighting factor to each of the plurality of valuations, determining a combined value estimate using the weighted plurality of valuations, generating one or more sets of property information responsive to the combined value estimate, and transmitting the generated one or more sets of property information via the portal.

### CROSS-REFERENCE TO RELATED APPLICATIONS

This application claims the benefit of U.S. Provisional Patent Application No. 63/159,979, filed Mar. 11, 2021, entitled “Apparatuses, Systems, and Methods for Providing an Automated Valuation Model For Commercial Real Estate,” which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

Numerous problems exist in the art in relation to property valuation, especially in the context of commercial property valuation. Property valuations are central to the workflows of commercial real estate investors, as they drive investments decisions, determine taxes and insurance, and impact financing options. Traditionally, valuations have been performed by appraisers, and can take hours or even days to complete for a single property. Automated Valuation Models (AVMs) have aimed to supplement and sometimes replace the traditional, labor-intensive appraisal process by using advanced models to generate “instant” property valuations. However, for commercial property, AVMs have not achieved the widespread usage they enjoy in the single-family residential space because of numerous issues arising in the commercial real estate space. This is because current commercial AVMs have lacked accuracy and transparency. Despite the advanced algorithms many of these models employ, they are still only as good as the data that drives them, most of which suffer from a “garbage-in, garbage-out” problem associated with input data. Further, because many of the models tout artificial intelligence as the backbone of their approach, they tend to be black boxes, thereby lacking transparency. Commercial real estate investors have been reluctant to adopt models they do not fully understand. Accordingly, what is needed are new valuation methods and systems.

### BRIEF SUMMARY

Embodiments of the present disclosure provide apparatuses, systems, and methods for providing an automated valuation model for commercial real estate. Provided herein are apparatuses, systems, and methods which resolve issues regarding shortcomings in accuracy and transparency of existing systems. By building a model around three recognized valuation approaches and fueling it with high-quality data sets, the timely and accurate valuation estimates for individual properties and portfolios may be provided. Furthermore, transparency is achieved despite the use of machine learning by providing relevant information regarding a subject property and parameters associated with each valuation and combined valuation associated with the subject property.

Implementations consistent with the present disclosure may include three valuation methods which are used to form a combined valuation in a new and useful manner. Specifically, a Net Operating Income (NOI) valuation may be used, a value extrapolation valuation may be used, and a comparables valuation may be used. The output for each the three valuation approaches may be dynamically weighted based on confidence scoring to calculate a final valuation estimate. Users of systems consistent with the present disclosure may choose to input additional property information to improve model confidence and/or accuracy.

Implementations consistent with the present disclosure may enable a method of providing an Automated Valuation Model (AVM), including providing a portal coupleable to a network interface, obtaining a plurality of valuations associated with a subject property via the portal, receiving at least one weighting factor associated with one or more of the plurality of valuations from a user via the portal, applying the least one weighting factor to each of the plurality of valuations, determining a combined value estimate using the weighted plurality of valuations, generating one or more sets of property information responsive to the combined value estimate, and transmitting the generated one or more sets of property information via the portal. The plurality of valuations may include a Net Operating Income (NOI) valuation, a value extrapolation valuation, and a comparable valuation. The method may include obtaining a set of property information associated with the subject property via the portal and calculating at least one of the obtained plurality of valuations based at least in part upon the obtained set of property information. The method may include generating at least one overview document for the subject property including information associated with the combined value estimate. Applying the at least one weighting factor to each of the plurality of valuations may include comparing a value associated with the at least one weighting factor to a predetermined value.

According to further aspects of the present disclosure, provided is a method of providing an Automated Valuation Model (AVM). The method includes providing a portal via a network interface, obtaining a set of property information associated with a subject property via the portal, calculating a plurality of valuations associated with a subject property based at least in part upon the obtained set of property information, applying at least one weighting factor to each of the plurality of valuations, and determining a combined value estimate using the weighted plurality of valuations. The plurality of valuations may include a Net Operating Income (NOI) valuation, a value extrapolation valuation, and a comparable valuation. The method may include generating at least one overview document for the subject property including information associated with the combined value estimate. Applying the at least one weighting factor to each of the plurality of valuations may include comparing a value associated with the at least one weighting factor to a predetermined value.

According to still further aspects of the present disclosure, provided is a system for providing an Automated Valuation Model (AVM). The system includes a network, a user device communicatively coupleable to the network and configured to transmit a set of property information via the network, and a computing device having a communication section communicatively coupleable to the network and configured to receive the set of property information via the network, the computing device configured to calculate a plurality of valuations associated with a subject property based at least in part upon the set of property information, and to determine a combined value estimate associated with the subject property. The computing device may include a weighting section configured to apply at least one weighting factor to each of the plurality of valuations to create a corresponding weighted plurality of valuations associated with the subject property, wherein the combined value estimate is determined using the weighted plurality of valuations associated with the subject property. The plurality of valuations may include a Net Operating Income (NOI) valuation, a value extrapolation valuation, and a comparable valuation. The computing device may include a generation section configured to generate at least one overview document for the subject property including information associated with the combined value estimate. The computing device may compare a value associated with the at least one weighting factor to a predetermined value. The computing device may provide a suggested value associated with one or more of the at least one weighting factors.

Numerous other objects, features, and advantages of the present disclosure will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 illustrates an exemplary embodiment of a partial block diagram of a user device in accordance with aspects of the present disclosure.

FIG. 2 illustrates an exemplary embodiment of a computing device according to aspects of the present disclosure.

FIG. 3 illustrates an exemplary embodiment of a partial block diagram of a server according to aspects of the present disclosure.

FIG. 4 illustrates an exemplary embodiment of a partial network diagram of a system according to aspects of the present disclosure.

FIG. 5 illustrates a flowchart providing an exemplary embodiment of a process for determining a property valuation according to aspects of the present disclosure.

FIG. 6 illustrates a flowchart providing an exemplary embodiment of a process for determining a Net Operating Income (NOI) capitalization valuation model according to aspects of the present disclosure.

FIG. 7 illustrates a flowchart providing an exemplary embodiment of a process for determining a Value Extrapolation (VE) valuation model according to aspects of the present disclosure.

FIG. 8 illustrates a flowchart providing an exemplary embodiment of a process for determining a comparable (COMP) valuation model according to aspects of the present disclosure.

FIG. 9 illustrates a flowchart providing an exemplary embodiment of a process for determining a combined valuation for a subject property according to aspects of the present disclosure.

FIG. 10 illustrates an exemplary embodiment of a property overview which may be generated by a generation section of a computing device according to aspects of the present disclosure.

FIG. 11 illustrates an exemplary embodiment of a smart comps interface for providing comparable property information according to aspects of the present disclosure.

FIG. 12 illustrates an exemplary embodiment of a single property valuation user interface configured to receive property information according to aspects of the present disclosure.

FIG. 13 illustrates an exemplary embodiment of the single property valuation user interface of FIG. 12 with property information entered via the interface.

FIG. 14 illustrates an exemplary embodiment of a smart comps scheme according to aspects of the present disclosure.

FIG. 15 illustrates an exemplary embodiment of a smart comps interface according to aspects of the present disclosure.

FIG. 16 illustrates an exemplary embodiment of a property overview according to aspects of the present disclosure.

FIG. 17 illustrates a flowchart of an exemplary embodiment of a method for providing a valuation according to aspects of the present disclosure.

FIG. 18 illustrates a flowchart of an exemplary embodiment of an assisted comp selection according to aspects of the present disclosure.

FIG. 19 illustrates a flowchart of an exemplary embodiment of a method for providing a custom weighted valuation for a property according to aspects of the present disclosure.

FIG. 20 illustrates a flowchart of an exemplary embodiment of a method for determining a property valuation according to a stabilization status according to aspects of the present disclosure.

FIG. 21 illustrates an exemplary embodiment of a property portfolio summary according to aspects of the present disclosure.

FIG. 22 illustrates an exemplary embodiment of a portfolio subset summary according to aspects of the present disclosure.

FIG. 23 illustrates an exemplary embodiment of a property list according to aspects of the present disclosure.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the implementations consistent with the present disclosure and do not delimit the scope of the present disclosure.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments consistent with the present disclosure, but their usage does not delimit the present disclosure, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

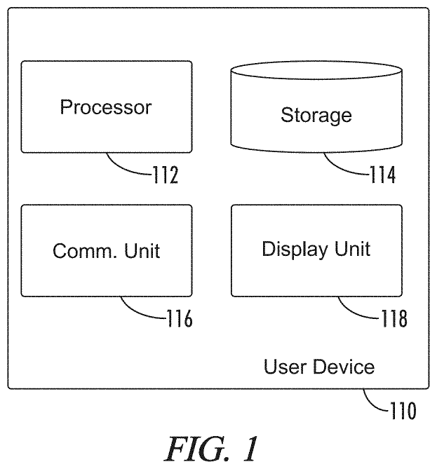

Referring generally to FIGS. 1-9 various exemplary apparatuses, systems, and associated methods according to the present disclosure are described in detail.

Where the various figures may describe embodiments sharing various common elements and features with other embodiments, similar elements and features are given the same reference numerals and redundant description thereof may be omitted below.

Various embodiments of an apparatus according to the present disclosure may provide apparatuses, systems, and methods for providing an automated valuation model for commercial real estate.

FIG. 1 illustrates an exemplary embodiment of a partial block diagram of a user device 100 in accordance with aspects of the present disclosure. The user device 110 may include one or more of a processor 112, a storage 114, a communication unit 116, and/or display unit 118. The processor 112 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor 112 may be any type of hardware and/or software processor and is not strictly limited to a microprocessor or any operation(s) only capable of execution by a microprocessor, in whole or in part.

The communication unit 116 of the user device 110 may be configured to permit communication (e.g., via the network 120 described herein), which may be performed by wired interface, wireless interface, or a combination thereof. The user device 110 may store one or more sets of instructions in a volatile and/or non-volatile storage 114. The one or more sets of instructions may be configured to be executed by the processor 112 to perform at least one operation corresponding to the one or more sets of instructions. The user device 110 may include a display unit 118. The display unit 118 may be embodied within the user device 110 in one embodiment and/or may be configured to be either wired to or wirelessly interfaced with the user device 110. The display unit 118 may be configured to operate, at least in part, based upon one or more operations of the described herein, as executed by the processor 112.

The user device 110 may be a standalone device or may be used in combination with at least one external component either locally or remotely communicatively coupleable with the user device 110 (e.g., via the network 120). The user device 110 may be configured to store, access, or provide at least a portion of information usable to permit one or more operations described herein. The user device 110 may additionally or alternatively be configured to store content data and/or metadata to enable one or more operations described herein.

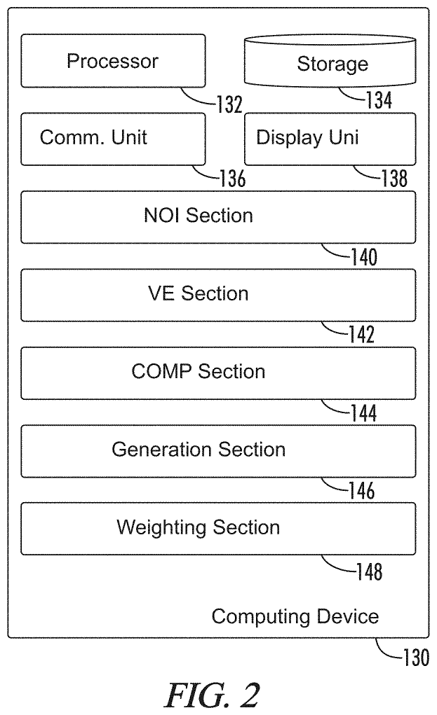

FIG. 2 illustrates an exemplary embodiment of a computing device 130 according to aspects of the present disclosure. The computing device 130 may include one or more of a processor 132, a storage 134, a communication unit 136, a display unit 138, a Net Operating Income (NOI) section 140, a Value Extrapolation (VE) section 142, a Comparable (COMP) section 144, a generation section 146, and/or a weighting section 148. At least one computing device 130 may be used to perform one or more operations or functions described herein, either alone or in combination with one or more other computing device 130 and/or other computing element.

The processor 132 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor 132 may be any type of hardware and/or software processor and is not strictly limited to a microprocessor or any operation(s) only capable of execution by a microprocessor, in whole or in part.

The communication unit 136 of the computing device 130 may be configured to permit communication (e.g., via the network 120 described herein), which may be performed by wired interface, wireless interface, or a combination thereof. The computing device 130 may store one or more sets of instructions in a volatile and/or non-volatile storage 134. The one or more sets of instructions may be configured to be executed by the processor 132 to perform at least one operation corresponding to the one or more sets of instructions. The computing device 130 may include a display unit 138. The display unit 138 may be embodied within the computing device 130 in one embodiment and/or may be configured to be either wired to or wirelessly interfaced with the computing device 130. The display unit 138 may be configured to operate, at least in part, based upon one or more operations of the described herein, as executed by the processor 132.

The computing device 130 may be a standalone device or may be used in combination with at least one external component either locally or remotely communicatively coupleable with the computing device 130 (e.g., via the network 120). The computing device 130 may be configured to store, access, or provide at least a portion of information usable to permit one or more operations described herein. For example, the computing device 130 may be configured to provide a portal, webpage, interface, and/or downloadable application to a user device 110 to enable one or more operations described herein. The computing device 130 may additionally or alternatively be configured to store content data and/or metadata to enable one or more operations described herein. The computing device 130 may be configured to provide a portal used to generate one or more interfaces as described herein. The one or more interfaces may be accessible to a user of the user device 110, for example via communications between the computing device 130 and the user device 110 via the network 120.

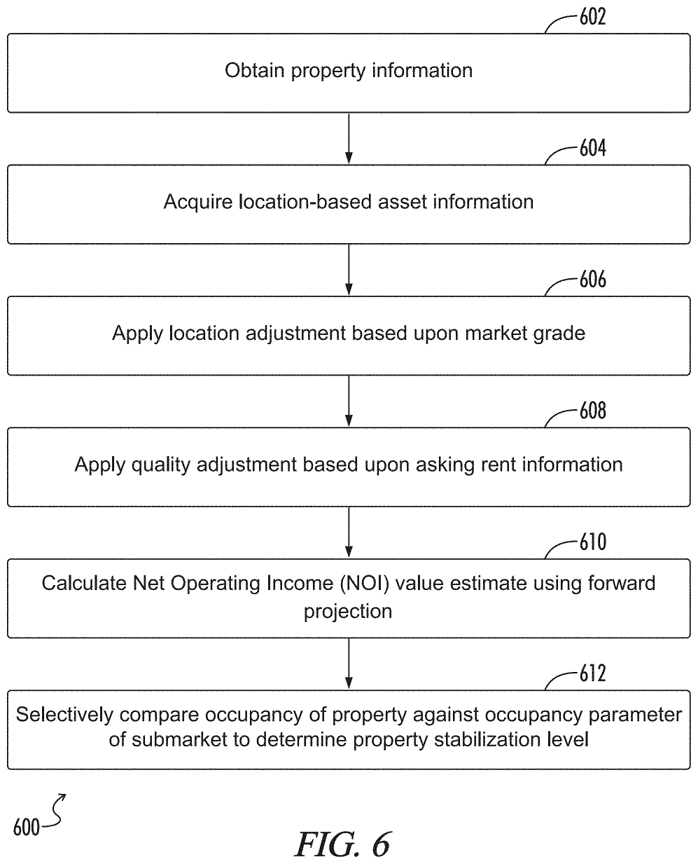

The NOI section 140 may be configured to perform at least one NOI valuation operation, for example on at least a portion of property information stored at, received by, or otherwise accessible to the computing device 130. Description of functionality provided by the NOI section 140 is described herein with reference to FIG. 6.

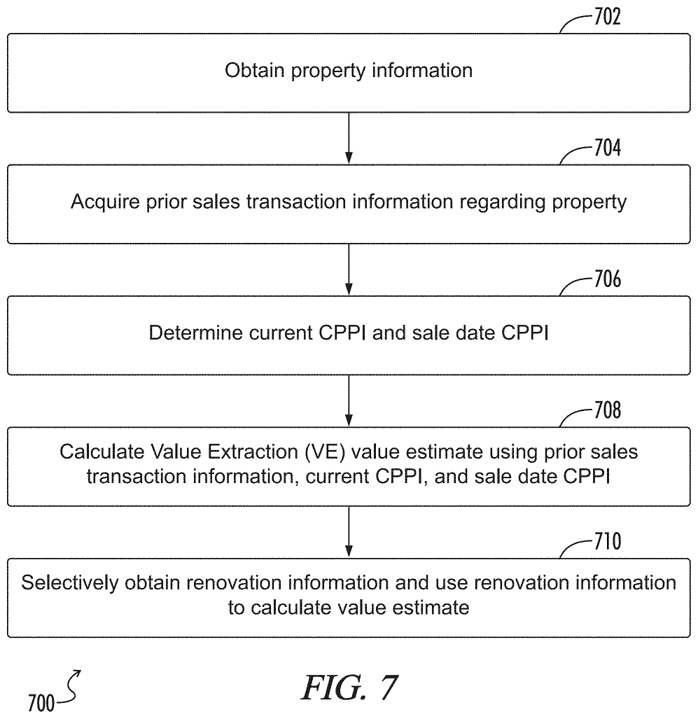

The Value Extrapolation (VE) section 142 may be configured to perform at least one value extrapolation operation, for example on at least a portion of property information stored at, received by, or otherwise accessible to the computing device 130. Description of functionality provided by the VE section 142 is described herein with reference to FIG. 7.

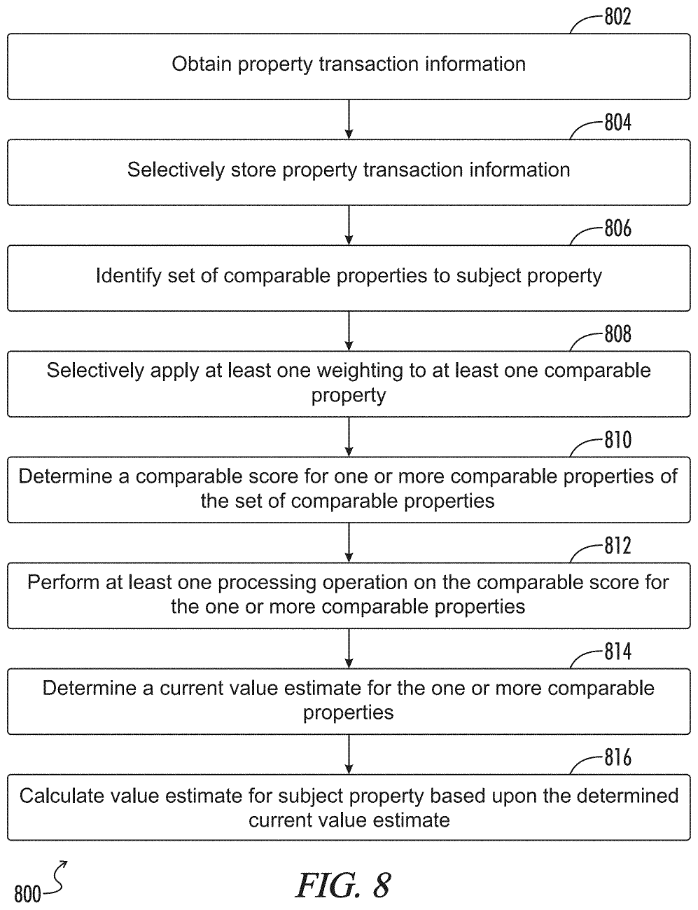

The COMP section 144 may be configured to perform at least one comparable valuation operation, for example on at least a portion of property information stored at, received by, or otherwise accessible to the computing device 130. Description of functionality provided by the COMP section 144 is described herein with reference to FIG. 8.

The generation section 146 is configured to provide one or more valuation generation operations, for example based at least in part upon one or more of a set of property information, information associated with the NOI section 140, information associated with the VE section 142, information associated with the COMP section 144, and/or one or more other sets of information or metadata.

The weighting section 148 is configured to provide one or more weighting operations, for example based at least in part upon one or more of a set of property information, information associated with the NOI section 140, information associated with the VE section 142, information associated with the COMP section 144, and/or one or more other sets of information or metadata.

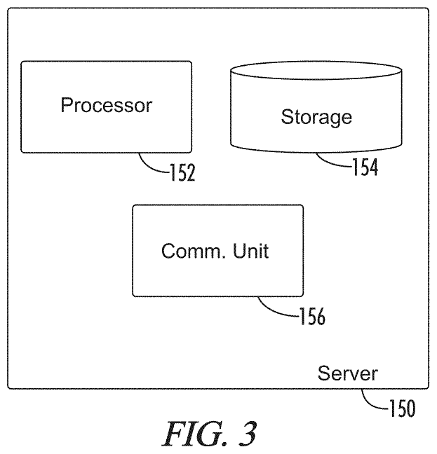

FIG. 3 illustrates a partial block diagram of an exemplary embodiment of a server 150 according to aspects of the present disclosure. One or more of the servers 150 described herein may include one or more devices configured to store data, to operate upon data, and/or to perform at least one action described herein. The server 150 may include one or more of a processor 152, a storage 154, and/or a communication unit 156.

The processor 152 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor 152 may be any type of hardware and/or software processor and is not strictly limited to a microprocessor or any operation(s) only capable of execution by a microprocessor, in whole or in part.

The communication unit 156 may be configured to permit communication (e.g., via the network 120 described herein), which may be performed by wired interface, wireless interface, or a combination thereof. Each server 150 may store one or more sets of instructions in a volatile and/or non-volatile storage 154. The one or more sets of instructions may be configured to be executed by the processor 152 to perform at least one operation corresponding to the one or more sets of instructions.

A plurality of servers 150 may be configured in a distributed manner, such as a distributed computing system, cloud computing system, or the like. At least one server 150 may be configured to provide information, metadata, and/or combination thereof in relation to property information or any information usable in a manner described herein to provide or to assist in providing an automated valuation model. Additionally or alternatively, one or more servers 150 may be structurally and/or functionally equivalent to the computing device 130. At least one server 150 may be a third-party server configured to provide information to the computing device 130 to permit or enhance at least one operation or function described herein as being performed by or in association with the computing device 130.

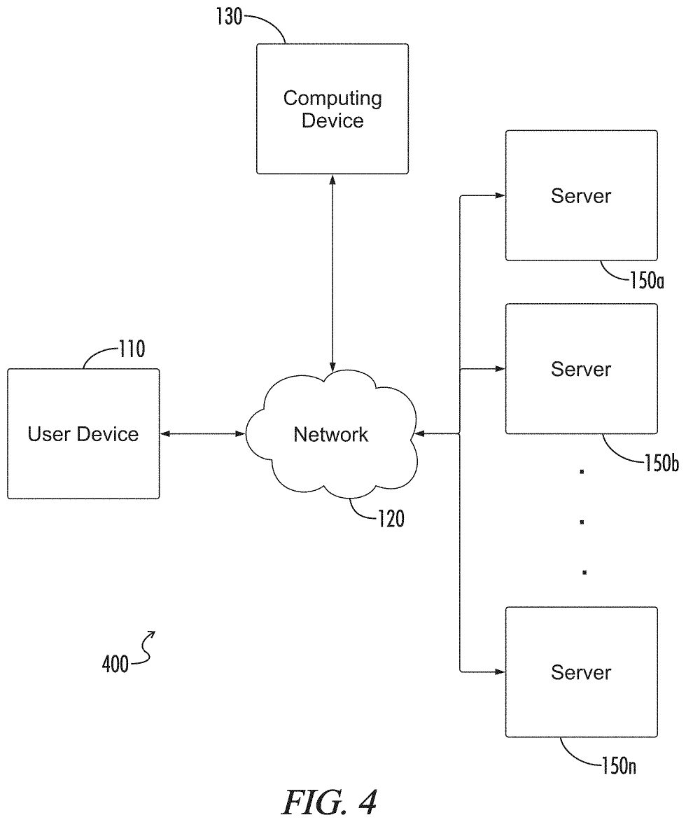

FIG. 4 illustrates a partial network diagram of an exemplary embodiment of a system 400 according to aspects of the present disclosure. The system 400 includes a simplified partial network block diagram reflecting a functional communicative configuration implementable according to aspects of the present disclosure. The system 400 includes a user device 110 coupleable to a network 120, a computing device 130 coupleable to the network 120, and one or more electronic devices 150a, 150b, . . . , 150n coupleable to the network 120. In one exemplary embodiment, the network 120 includes the Internet, a public network, a private network, or any other communications medium capable of conveying electronic communications, either alone or in combination. Connection between one or more computing elements described herein and the network 120 is configured to be performed by wired interface, wireless interface, or a combination thereof, without departing from the spirit and the scope of the present disclosure.

Model inputs consistent with the present disclosure may include one or more of an address, a property sector, a size, a Net Operating Income (NOI), and/or occupancy. The address may include any address, for example any address within the largest 384 Metropolitan Statistical Areas (MSAs) in the United States. The property sector may include, for example, an apartment sector, an industrial office sector, a strip center sector, or any other commercial property sector. In various exemplary embodiments, for a strip center sector, a user of the user device 110 may be permitted to select a neighborhood, community center, or power center and may be able to specify that a selection includes or does not include a grocer. The size may be specified, for example, in units or in square feet. The NOI may be implemented as a Last Twelve Months (LTM) NOI value as used herein, although any time period of forward or reverse projection of NOI may be used without departing from the spirit and scope of the present disclosure. A user may be permitted to enter the occupancy, for example, as an LTM average or other measurement of occupancy.

A user at the user device 110 may be further permitted to provide one or more optional inputs, which may be used to improve model accuracy. The one or more optional inputs may include, without limitation, an average asking rent value, a last sale date value, a last sale price value, a date renovated value, and/or a renovation cost value. Each property may be assigned a unique identifier (ID), which can be the property name in various embodiments. Systems consistent with the present disclosure may be configured such that if a property name is not provided, the unique ID is provided a default value of the subject property's physical address. If any data is entered in an incorrect format or is outside the scope of one or more parameters, the user may be requested to correct the errors.

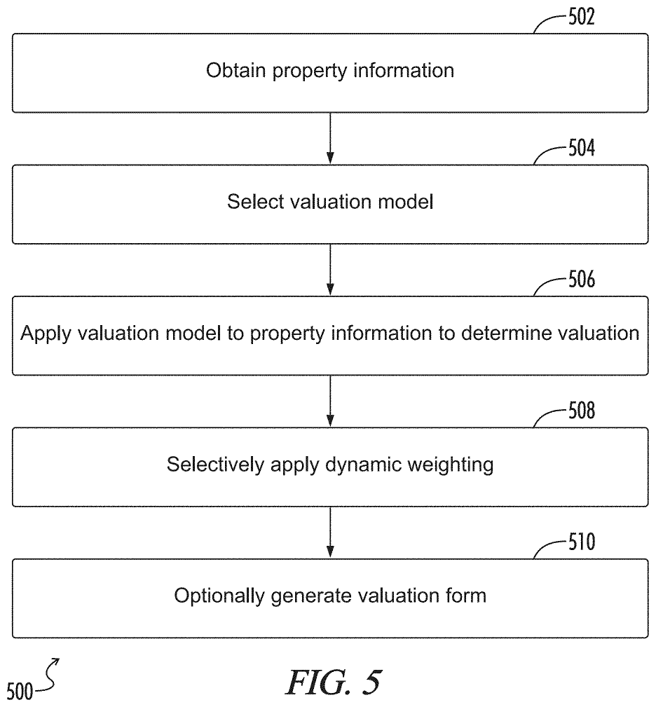

FIG. 5 illustrates a flowchart providing an exemplary embodiment of a process 500 for determining a property valuation according to aspects of the present disclosure. The process 500 begins at an operation 502 where at least one set of property information is obtained, for example by the computing device 130 via the network 120. The at least one set of property information may include one or more attributes associated with a subject property, such as physical attributes, and may additionally or alternatively include one or more additional values associated with the subject property and/or metadata relating to the subject property. The at least one set of property information may include, for example, a location of a subject property, a type of property, one or more parameters associated with the property, sale information, renovation information, and/or combination thereof. In various embodiments, the at least one set of property information may be obtained by the computing device 130 from a user device 110 and/or from one or more servers 150 via the network 120 (e.g., via a portal provided by the computing device 130 in an exemplary embodiment). The at least one set of property information may include data and/or metadata relating to a plurality of subject properties in various embodiments. At least a portion of the at least one set of property information may be stored at the computing device 130, for example at the storage 134 thereof.

The process 500 may continue to an operation 504 where a valuation model is selected. The valuation model may be selected from a plurality of valuation models. The computing device 130 may provide a plurality of models, for example an NOI valuation model using the NOI section 140, a VE valuation model using the VE section 142, and/or a comparable valuation model using the COMP section 144. Although these three valuation models are described as being provided by the computing device 130, it should be appreciated that one or more additional or alternative valuation models may be implemented in according with aspects of the present disclosure, and are not required to be implemented, in whole or in part, by the computing device 130 (e.g., one or more valuation models consistent with the present disclosure may be provided by at least one server 150 and/or user device 110).

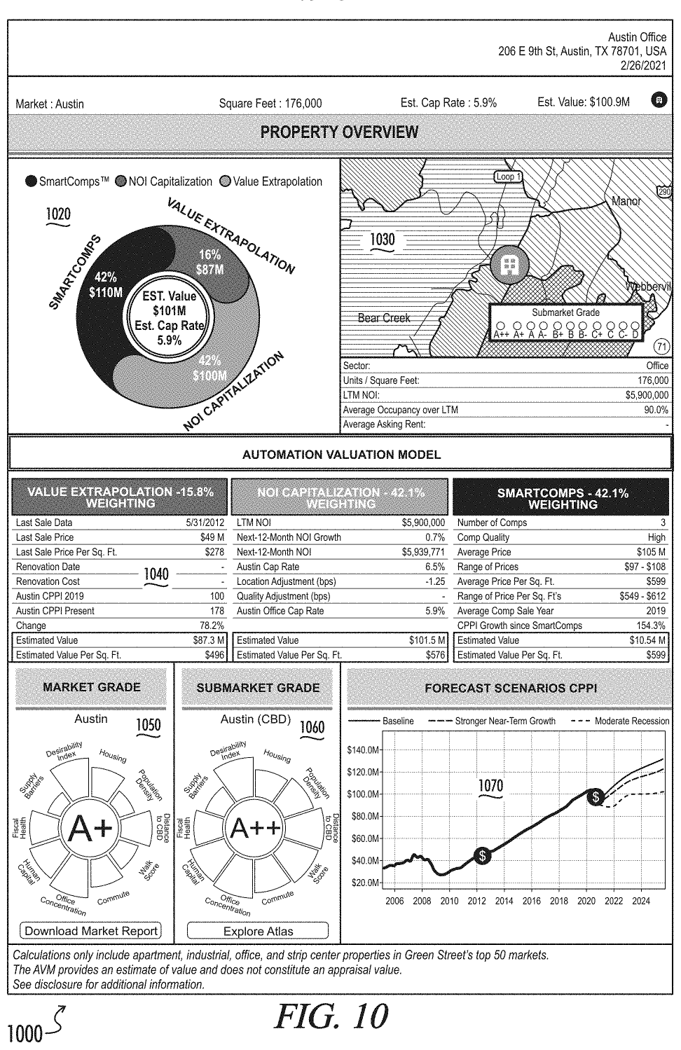

Once the valuation model is selected at the operation 504, the process 500 may continue to an operation 506 where the valuation model is applied to the property information obtained at the operation 502 to determine a valuation for a subject property. One or more dynamic weightings may be selectively applied at an operation 508 during the subject property valuation determination of the operation 506, for example using the weighting section 148 of the computing device 130. At least one valuation form may be optionally generated by the computing device at an operation 510. Examples of valuation forms are illustrated in FIGS. 10, 11 and 21-23 described below.

FIG. 6 illustrates a flowchart providing an exemplary embodiment of a process 600 for determining a Net Operating Income (NOI) capitalization valuation model according to aspects of the present disclosure.

Under the NOI capitalization approach, a Last Twelve Months (LTM) NOI provided by a user of the user device 110 is divided by a Green Street estimated capitalization (cap) rate for that specific property. The derivation of the property-specific cap rate starts by obtaining a cap rate estimate for the relevant property sector and Metropolitan Statistical Area (MSA). Systems consistent with the present disclosure may maintain a real-time database of cap rates for “average quality” assets across a plurality of property sectors and a plurality of MSAs (e.g., 384 MSAs). “Average quality” is defined as a property with asking rents in line with the average rents for the MSA in which the property sits. The assigned “average quality” cap rate may then be adjusted based on two factors: asset location and asset quality.

### Location Adjustment Based on Market Grade

Letter grades may be assigned to each zip code in a group of U.S. MSAs (e.g., the Top 50 MSAs), with the grade representing long-term rent growth potential. Each grade may include a plurality of variables specific to each sector—with a subjective adjustment, if necessary. In an exemplary embodiment, a higher grade may equate to better long-term growth. Each subject property may be automatically matched to its corresponding zip code and market grade. If the assigned grade of the subject property is better than the market average grade, the nominal cap rate maybe adjusted lower, and vice-versa.

### Quality Adjustment Based on Asking Rents

The asking rent value of a property relative to the overall market in which the property sits tends to be a good indicator of property quality. If the user of the user device 110 inputs the optional subject property asking rent value to a system as described herein, it will be benchmarked to the market average rent so that property quality can be inferred. If the subject property rent is higher than the average rent in that market (e.g., higher quality asset), the nominal cap rate may be adjusted accordingly. When the optional rent input is not provided by the user of the user device 110, the submarket-level rent data may be used to infer the subject's property quality. Properties within the same market and sector may thus utilize custom cap rate metrics in the estimation of value, thereby capturing idiosyncrasies of the property as well as the submarket the property is in.

### Forward NOI Adjustment

Cap rates may be based on forward, or Next Twelve Months (NTM) NOI, the LTM NOI provided by the user of the user device 110 may be converted to a NTM NOI by utilizing a hybrid market/sector NOI forecast. This new NTM NOI is then divided by the derived property-specific cap rate to produce a valuation estimate, as reflected by Equation 1 below.

$$Value Estimate = LTM NOI \times \frac{1 + NTM NOI growth}{Property Specific Cap Rate} \qquad Equation 1$$

### Non-Stabilized Properties

A property's current occupancy is one of a plurality of inputs for systems consistent with the present disclosure. The occupancy of a subject property may be automatically checked against the average occupancy of the subject property's submarket to determine if the property is stabilized. If the subject property is determined to be operating below a stabilized occupancy level, a lease-up logic may be triggered based on market-level rents and operating margins valuation model. Since it is not possible to know whether a property is operating at a below-market occupancy level due to the asset being repositioned, or because the asset is physically or functionally obsolete versus comparable buildings (e.g., vacancy should be elevated vs market for structural reasons), occupancy is not adjusted all the way back to the market average. This “closing percentage” may be laid out, for example, as follows:

Apartment - 80%
Industrial - 70%
Office - 60%
Strip Center - 40%

For example, if an apartment property is currently 70% occupied in a market with average occupancy of 95% (e.g., the occupancy is 25% below market), final occupancy used for the model is 70%+(25%×80%)=90%. Said differently, the NOI is grossed up to reflect a property operating at 90% occupancy. The value estimate equation may be reflected as provided by Equation 2, below.

$$Value Estimate = \frac{\begin{matrix}( LTM NOI + Non - Stabilized NOI Gross Up ) \times \\ ( 1 + NTM NOI Growth )\end{matrix}}{Property Specific Cap Rate} \qquad Equation 2$$

In FIG. 6, the process 600 for determining a NOI capitalization valuation begins at an operation 602 where at least one set of property information is obtained by the computing device 130. The at least one set of property information may include one or more attributes associated with a subject property, such as physical attributes, and may additionally or alternatively include one or more additional values associated with the subject property and/or metadata relating to the subject property. The at least one set of property information may include, for example, a location of a subject property, a type of property, one or more parameters associated with the property, sale information, renovation information, and/or combination thereof. In various embodiments, the at least one set of property information may be obtained by the computing device 130 from a user device 110 and/or from one or more server 150 via the network 120 (e.g., via a portal provided by the computing device 130 in an exemplary embodiment). The at least one set of property information may include data and/or metadata relating to a plurality of subject properties in various embodiments. At least a portion of the at least one set of property information may be stored at the computing device 130, for example at the storage 134 thereof.

The process 600 may continue to an operation 604 where location-based asset information is acquired by the computing device 130. At least a portion of the location-based asset information may be obtained, for example, from a user device 110 and/or from one or more servers 150 via the network 120 (e.g., via a portal provided by the computing device 130 in an exemplary embodiment). One or more sets of location-based asset information may be optionally stored at the computing device, for example at the storage 134 thereof. The location-specific asset information may include Metropolitan Statistical Area (MSA) information associated with a subject property, for example including asset location and quality information or metadata. The process 600 then continues to an operation 606 where at least one location adjustment is applied based upon a market grade of the subject property. A quality adjustment may then be applied based upon asking rent information associated with the subject property at an operation 608. After the location and quality adjustments are applied, a value estimate is calculated at an operation 610 using forward projection. An occupancy of a subject property may be selectively compared against an occupancy value of a submarket of the subject property at an operation 612 to determine a property stabilization level value which may be associated with the subject property and optionally provided to a user of the user device 100, for example via at least one valuation form generated by the computing device 130.

FIG. 7 illustrates a flowchart providing an exemplary embodiment of a process 700 for determining a Value Extrapolation (VE) valuation model according to aspects of the present disclosure.

The value extrapolation approach is a second prong of the methodology provided herein. Application of the value extrapolation approach may use one or more Commercial Property Price Indices (CPPIs) to update or to extrapolate a prior sales transaction price to reflect current valuation. A CPPI may be a weighted time series of unleveraged U.S. commercial property values that captures the prices at which commercial real estate transactions are currently being negotiated and contracted. Systems consistent with the present disclosure may generate CPPIs for multiple property sectors (e.g., all four major property sectors) across a plurality of MSAs (e.g., 384 MSAs). The value extrapolation math is reflected below with reference to Equation 3.

$$Value Estimate = Sale Price \times \frac{CPPICurrent}{CPPISaleDate} \qquad Equation 3$$

### Renovations

While one or more CPPIs may represent changes in the value of stabilized assets, they might exclude property-specific value appreciation tied to large scale renovations. To account for this, implementations consistent with the present disclosure may allow the user of the user device 110 to enter optional information pertaining to when, and how much, was invested on a recent renovation. Because renovations are sometimes just deferred maintenance in disguise, and oftentimes experience rapidly decaying return on invested capital, a reduction of the renovation amount, based on sector type and time since the renovation, may be applied. The Value Estimate may thus be reflected by Equation 4, below.

$$Value Estimate = Sale Price \times \frac{CPPICurrent}{CPPISaleDate} + ( Renovation Amount \times Renovation Credit ) \times \frac{CPPICurrent}{CPPIRenovationDate} \qquad Equation 4$$

In FIG. 7, the process 700 for determining a value extrapolation valuation begins at an operation 702 where at least one set of property information is obtained by the computing device 130. The at least one set of property information may include one or more attributes associated with a subject property, such as physical attributes, and may additionally or alternatively include one or more additional values associated with the subject property and/or metadata relating to the subject property. The at least one set of property information may include, for example, a location of a subject property, a type of property, one or more parameters associated with the property, sale information, renovation information, and/or combination thereof. In various embodiments, the at least one set of property information may be obtained by the computing device 130 from a user device 110 and/or from one or more servers 150 via the network 120 (e.g., via a portal provided by the computing device 130 in an exemplary embodiment). The at least one set of property information may include data and/or metadata relating to a plurality of subject properties in various embodiments. At least a portion of the at least one set of property information may be stored at the computing device 130, for example at the storage 134 thereof.

The process 700 may continue to an operation 704 where prior sales information associated with a subject property is obtained by the computing device 130, for example from at least one server 150 via the network 120. Additionally or alternatively, at least a portion of the prior sales information may be stored at the storage 134 of the computing device 130 or may be otherwise accessible to the computing device 130. The process 700 then continues to an operation 706 where a current CPPI and a sale date CPPI are determined for the subject property. The current CPPI and sale date CPPI values are then used at an operation 708 along with the prior sales transaction information to calculate a value estimate for the subject property. The process 700 selectively includes obtaining at least one set of renovation information at an operation 710 and using the at least one set of renovation information to calculate the value estimate of the operation 708.

FIG. 8 illustrates a flowchart providing an exemplary embodiment of a process 800 for determining a comparable (COMP) valuation model according to aspects of the present disclosure.

The third prong of the methodology provided herein is based on transaction comparables. Implementations consistent with the present disclosure may include establishing and maintaining a deep and accurate database of verified transaction comps (e.g., as stored at the storage 134 of the computing device 130) and may employ an algorithm called SMARTComps™ against that database to identify one or more relevant comps for a subject property. SMARTComps™ may employ a decision tree logic developed to select the best comps based at least in part upon one or more of:
Recency of the transaction
Pricing bands
Distance to subject property
Similarity in property characteristics, specifically size

An optimization process may be performed to select one or more optimal weights for the four metrics, and upper and lower bounds put in place to determine if properties are eligible for inclusion. Then, a numeric score may be calculated for each eligible property, and the best comps (e.g., top 10) may be selected and selectively displayed. Subsequently, the numeric score for the best comps (e.g., ten properties) may be standardized and weighted (e.g., some comps get more weight than others based on the quality of the “match”). For each of the comps selected, the price per unit/sq ft may be “brought current” based on its last sale date, and multiplied by its corresponding unit/sq ft. The final value estimate is then a weighted average of those current prices. The Value estimate may then be reflected as provided by Equation 5. In Equation 5, the value i is a selected comp and N is a total number of selected comps.

$$Value Estimate = {\sum }_{i = 1}^{N} ( Subject Property units / sqft ) \times {( Current Price per unit / sqft )}_{i} \times {( Match Quality Weight )}_{i} \qquad Equation 5$$

In FIG. 8, the process 800 for determining a comparable valuation begins at an operation 802 where at least one set of property transaction information is obtained by the computing device 130. The at least one set of property transaction information may include one or more attributes associated with a subject property, such as physical attributes and sale transaction information, and may additionally or alternatively include one or more additional values associated with the subject property and/or metadata relating to the subject property. The at least one set of property transaction information may include, for example, a location of a subject property, a type of property, one or more parameters associated with the property, sale information, renovation information, and/or combination thereof. In various embodiments, the at least one set of property transaction information may be obtained by the computing device 130 from a user device 110 and/or from one or more server 150 via the network 120 (e.g., via a portal provided by the computing device 130 in an exemplary embodiment). The at least one set of property transaction information may include data and/or metadata relating to a plurality of subject properties in various embodiments.

The process 800 may continue to an operation 804 where at least a portion of the at least one set of property transaction information is selectively stored at the computing device 130, for example at the storage 134 thereof. A set of comparable properties to the subject property is identified at an operation 806. At least one weighting is selectively applied to at least one comparable property at an operation 808, for example by the weighting section 148 of the computing device 130. A comparable score is then determined at an operation 810 for one or more comparable properties of the set of comparable properties. At least one processing operation 812 is performed to adjust or modify the information for the one or more comparable properties. A current value estimate is determined at an operation 814 for the one or more comparable properties. A value estimate for the subject property is calculated at an operation 816 based upon the determined current value estimate.

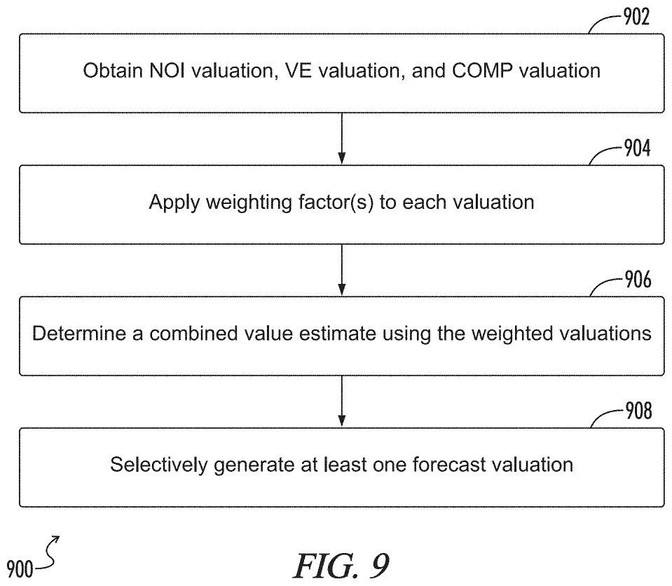

FIG. 9 illustrates a flowchart providing an exemplary embodiment of a process 900 for determining a combined valuation for a subject property according to aspects of the present disclosure.

As previously described, implementations consistent with the present disclosure may influenced by three valuation approaches: NOI Capitalization valuation, value extrapolation valuation, and comparables valuation. The final estimate of value according to aspects of the present disclosure may be a weighted combination of the three approaches, with the weight of each approach calculated dynamically given a confidence score. In addition, insights from machine learning and predictive analytics may be employed within the system to enhance the final value estimation. Examples of these include classifying the criteria and logic in the selection of the best comps to the subject property, identifying factors that are deemed to be important drivers of property valuation, as well as optimizing weighting schemas under the three-prong approach to derive the final valuation estimate. As such, if a user of the user device 110 runs a portfolio of assets through systems consistent with the present disclosure, the weightings of each approach can vary significantly from property to property.

### Confidence Scoring Overview

NOI Capitalization: A confidence score may depend upon property occupancy status. The closer to a stabilized level of occupancy the higher the confidence. Additionally, if the user of the user device 110 provides an asking rent which allows for a better estimate of property quality, the confidence score may be increased.

Value Extrapolation: The more recent a sale, the higher the confidence score may be. In the extreme, if a property sold yesterday, the system may assign large weight (e.g., 99%) to the value extrapolation prong as the value is largely known. It should be noted that a recent sale might not reflect true market value if the sale represents the exercise of a pre-negotiated purchase option. In these instances, the output of the value extrapolation prong may be discounted. Additionally, if an optional renovation amount and last sale date are filled in, the confidence score might be increased.

Comparables: A higher confidence score may be attributed to more recent and robust transaction activity that is similar to the subject property.

Output from systems consistent with the present disclosure may be simple and transparent, and may display information such as a final value estimate, value estimates from the three individual approaches, weightings applied to each approach, build-up of value within each approach, property cap rate applied, market grade applied, listing of comparable properties used, and/or other information relating to or in association with a subject property.

As an added feature, the output report might also take a final value estimate and provide a future forecast for that value (e.g., a five-year forecast) under different economic scenarios using the information.

In FIG. 9, the process 900 for providing a combined valuation begins at an operation 902 where a Net Operating Income (NOI) valuation, a Value Extrapolation (VE) valuation, and a Comparable (COMP) valuation are obtained for a subject property. The NOI valuation may be obtained, for example, from the NOI section 140 of the computing device 130, the VE valuation may be obtained, for example, from the VE section 142 of the computing device 130, and the COMP valuation may be obtained, for example, from the COMP section 144 of the computing device 130. Additionally or alternatively, one or more of the NOI valuation, the VE valuation, the COMP valuation, and/or one or more additional valuations may be obtained from the computing device 130, the server 150, the user device 110, or any other source of valuation data or metadata.

The process 900 may include applying one or more weighting factor(s) to the obtained valuations for the subject property at an operation 904. In an exemplary embodiment, at least one weighting factor is applied to each valuation. A combined value estimate is determined at an operation 906 using the weighted valuations. At least one forecast valuation for a subject property may be selectively generated at an operation 908.

FIG. 10 illustrates an exemplary embodiment of a property overview 1000 which may be generated by a generation section of a computing device according to aspects of the present disclosure. The property overview 1000 may be selectively displayable via a visual interface of a computing device 130, such as a display screen in various embodiments or may otherwise be configured to convey at least a portion of information to a user using or in alternative to a computing device 130. The property overview 1000 may include a header section 1010 at a portion thereof. The header section 1010 may be configured to convey at least a portion of information associated with a property, such as a market, a size (e.g., total square footage), an estimated capitalization rate, and estimated value, or any other set of information regarding or associated with a property or group of properties.

The property overview 1000 may further include a valuation model section 1020. The valuation model section 1020 may visually convey information regarding one or more valuation models used by or usable to determine at least one valuation associated with a property or group of properties. In the embodiment illustrated by FIG. 10, three valuation models are shown: a COMP valuation model, an NOI valuation model, and a VE model, although it should be appreciated that fewer or additional valuation models and corresponding information may be provided by the valuation model section 1020 without departing from the spirit and scope of the present disclosure.

The property overview 1000 may further include a sector map section 1030. The sector map section 1030 may provide a visual map of areas surrounding a property location or group of property locations. One or more submarket sections may be visually segmented in the sector map section 1030. One or more of the submarket sections may be associated with a submarket grade. The submarket grade for one or more of the submarket sections may be presented on the sector map section, for example by varying colors or shading associated with a score assigned or otherwise determined for the at one or more of the submarket sections. A sector associated with a property or group of properties may be identified and one or more sets of information relating to such may be provided. For example, in the embodiment illustrated by FIG. 10, a sector name, a units/square feet value, an LTM NOI value, and average occupancy over LTM value, and an average asking rent value are provided, although additional or fewer sets of information may be provided without departing from the spirit and scope of the present disclosure.

An automated valuation model breakdown section 1040 may be provided by the property overview 1000. The automated valuation model breakdown section 1040 may include one or more of the valuation models identified at the valuation model section 1020 and may contain information regarding one or more sets of information used by, accessible to, or determined by one or more of the valuation models. Each valuation model identified in the automated valuation model breakdown section 1040 may have a corresponding estimated value and optionally estimated value per square foot value provided.

A market grade section 1050 may be provided to visually convey information regarding a particular market. Information which may be conveyed includes, but is not limited to, a housing index, a population density, a distance to CBD value, a walk score, a commute score, an office concentration score, a human capital score, a fiscal health score, a supply barriers score, and a desirability index value. One or more additional or alternative values or information may be used in various embodiments. A link may be provided to download a market report associated with the market identified in the market grade section 1050. A submarket grade section 1060 may be provided to visually convey information regarding a particular submarket. Information which may be conveyed includes, but is not limited to, a housing index, a population density, a distance to CBD value, a walk score, a commute score, an office concentration score, a human capital score, a fiscal health score, a supply barriers score, and a desirability index value. One or more additional or alternative values or information may be used in various embodiments. An explore atlas link may be provided in association with the identified submarket and/or to select a different submarket for review or analysis.

A forecast scenarios section 1070 may be provided by the property overview 1000. The forecast scenarios section 1070 may include a graph or chart providing a timeline including a CPPI value over time, and optionally according to one or more projections. In the embodiment illustrated by FIG. 10, such one or more projections may include a baseline, a stronger near-term growth rate, and/or a moderate recession rate, although additional or fewer projections may be provided without departing from the spirit and scope of the present disclosure.

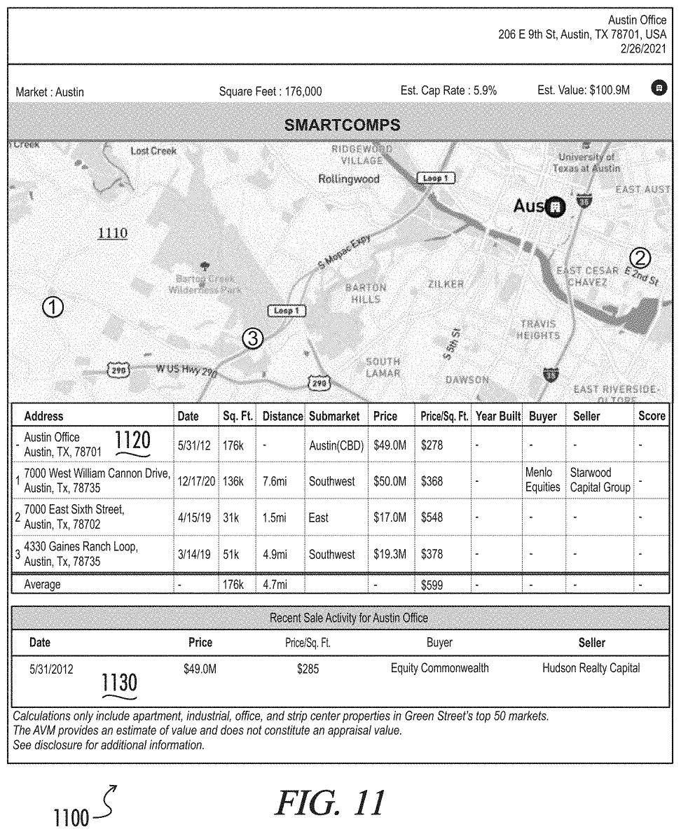

FIG. 11 illustrates an exemplary embodiment of a smart comps interface 1100 for providing comparable property information according to aspects of the present disclosure. The smart comps interface 1100 includes one or more of a map section 1110, a comps listing section 1120, and/or a recent sale information section 1130. The map section 1110 may provide a visual interface providing the location(s) of a subject property and one or more comparable property locations used or otherwise usable in determining a value for a subject property. The comps listing section 1120 may include information regarding one or more comparable properties associated with the subject property. The comps listing section 1120 may include information including, but not limited to, an address, a date of sale or entry, a size (such as a square footage), a submarket identifier, a price value, a price per size value, such as price per square foot, a build or market date (such as year), a buyer identifier, a builder identifier, a seller identifier, a property score value, or other information regarding or otherwise associated with a property, or combination thereof. The recent sale information section 1130 may include information relation to sales information regarding a subject property and/or related properties. For example, the recent sale information section 1130 may include a transaction date, a price value, a relative price per size value (e.g., as a price per square foot value), buyer information, seller information, additional information and/or metadata regarding the subject or other property, or combination thereof.

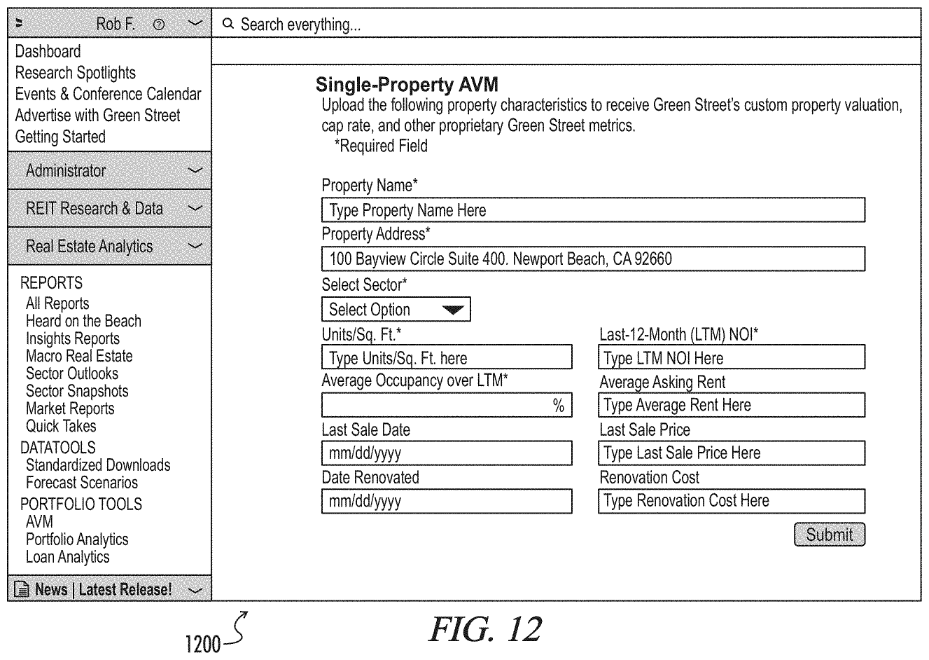

FIG. 12 illustrates an exemplary embodiment of a single property valuation user interface 1200 according to aspects of the present disclosure. The single property valuation may include a user interface configured with data input boxes to receive one or more sets of information, for example including a property name, a property address, a sector selection, a unit per size value (e.g., unit per sq. ft.), a last twelve-month NOI, an average occupancy over LTM, an average asking rent, a last sale date, a last sale price, a last renovated date, a renovation cost, and/or one or more of the preceding alone or in combination with one or more additional values.

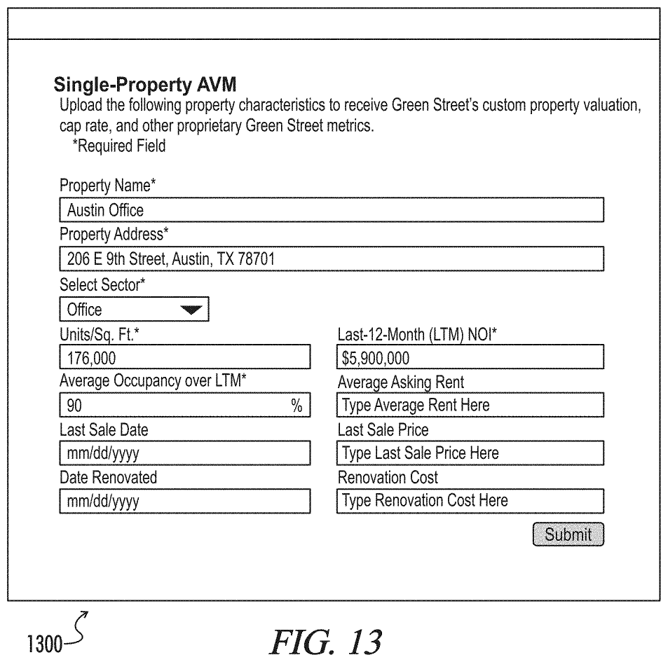

FIG. 13 illustrates an exemplary embodiment of a single property valuation user interface 1300 corresponding to the user interface 1200 of FIG. 12. The user interface 1300 shows information entered into selected data input boxes.

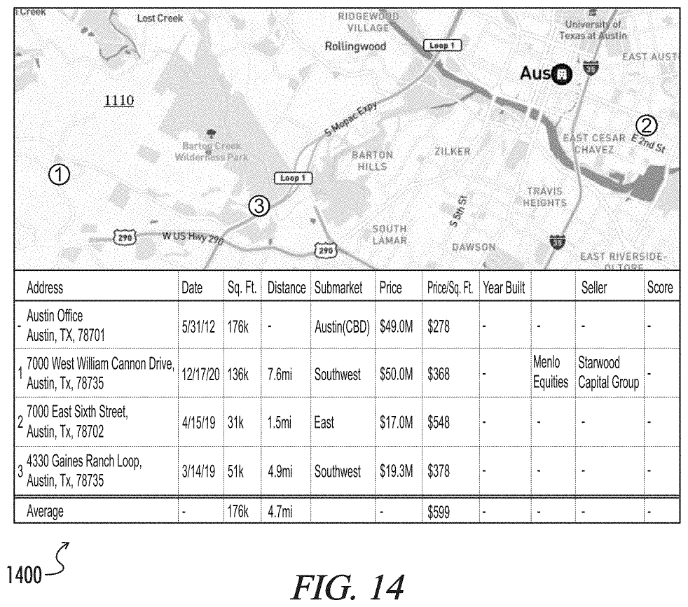

FIG. 14 illustrates an exemplary embodiment of interface 1400 for a smart comps scheme according to aspects of the present disclosure. The interface 1400 has one or more of a map section and a details section. The map section may include a visual conveyance of information including, but not limited to, an address, a date of sale or entry, a size (such as a square footage), a submarket identifier, a price value, a price per size value, such as price per square foot, a build or market date (such as year), a buyer identifier, a builder identifier, a seller identifier, a property score value, or other information regarding or otherwise associated with a property, or combination thereof. The interface 1400 may include information relation to sales information regarding a subject property and/or related properties. For example, the interface 1400 may include a transaction date, a price value, a relative price per size value (e.g., as a price per square foot value), buyer information, seller information, additional information and/or metadata regarding the subject or other property, or combination thereof.

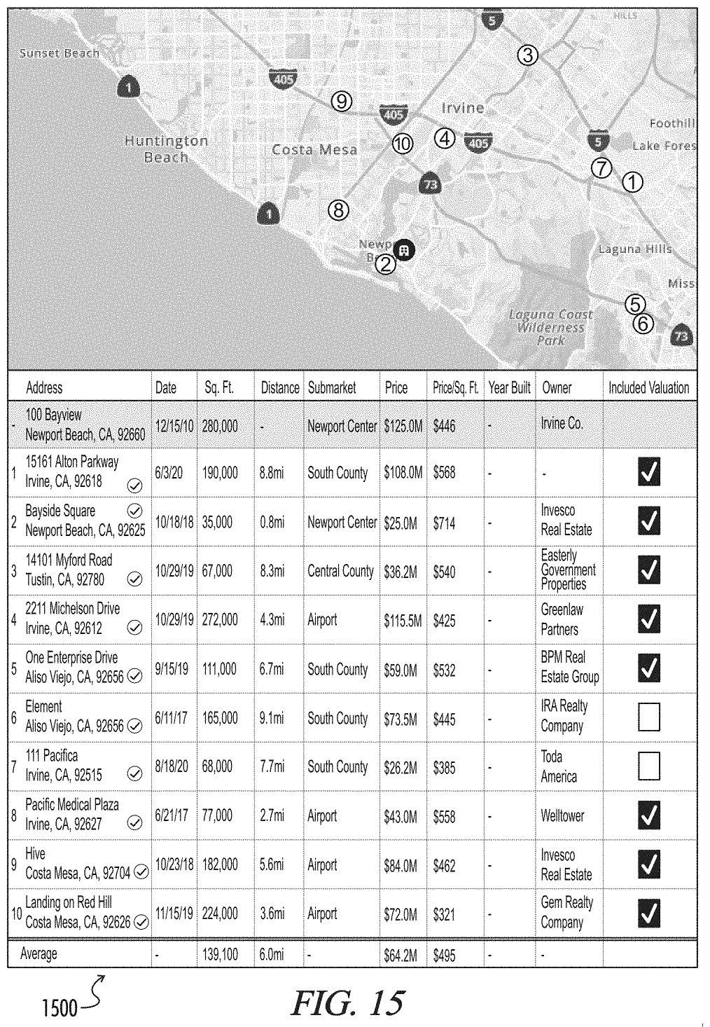

FIG. 15 illustrates an exemplary embodiment of a smart comps interface 1500 according to aspects of the present disclosure. The smart comps interface 1500 may include a graphical map section and a property information section. The graphical map section may include one or more comparable properties visualized on a map. The property information section may include at least one of a property address, a listing date, a square footage value, a distance from location value, a submarket value, a price value, a price per location value (e.g., price per square foot) a year built value, an owner value, and/or one or more selectable options relating to one or more values used to determine valuation. In various exemplary embodiments, one or more user-selectable values may be associated with those included in a property valuation.

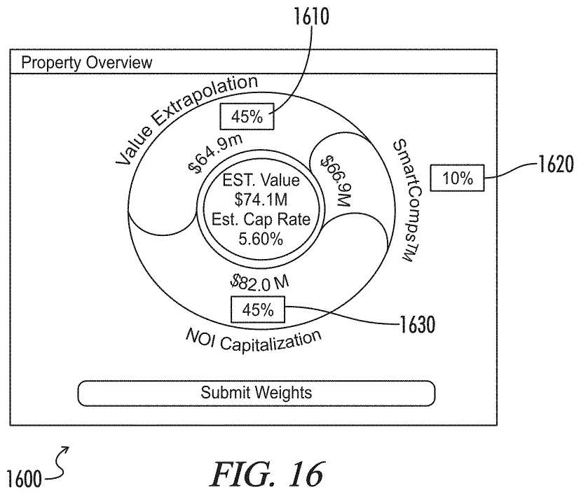

FIG. 16 illustrates an exemplary embodiment of a property overview 1600 according to aspects of the present disclosure. The property overview 1600 may include a value extrapolation section 1610, a smart comp section 1620, and/or an NOI capitalization section 1630. The property overview 1600 and/or portion thereof may permit a user to provide one or more values, sub-values, relationships, and/or one or more other and/or additional reporters. One or more of the value extrapolation values, the smart comps value, and/or the NOI capitalization numbers may be provided with a weight value adding to a total value of 100 in various embodiments. An estimated value and/or estimated cap rate may be provided by the property overview 1600, for example based at least in part upon one or more weights provided to one or more of the value extrapolation section 1610, the smart comp section 1620, and/or the NOI capitalization section 1630.

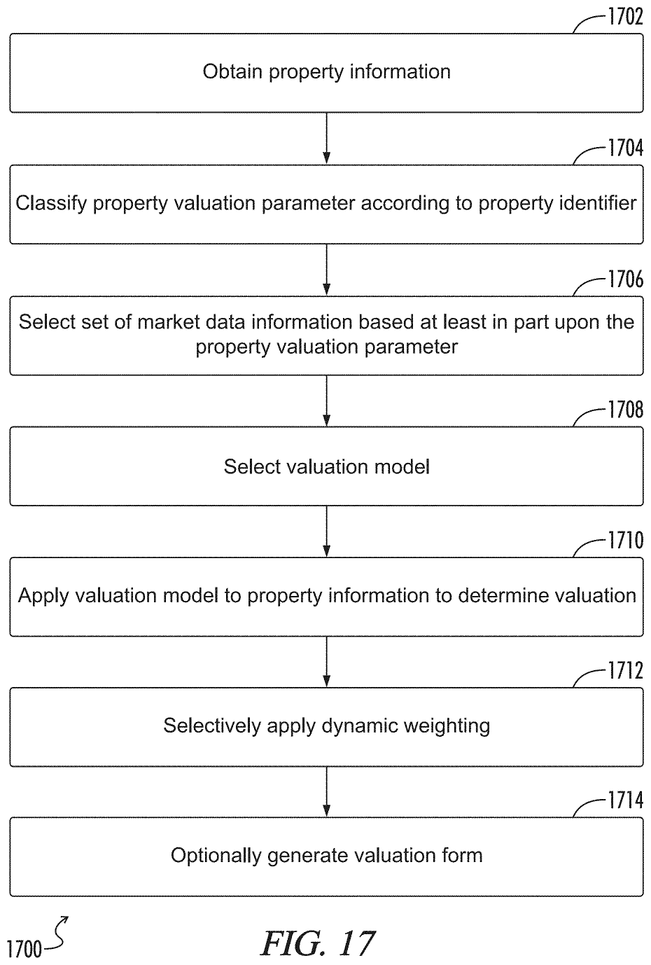

FIG. 17 illustrates an exemplary embodiment of a method 1700 for providing a valuation according to aspects of the present disclosure. The method 1700 includes an operation 1702 where property information is obtained. The property information may be obtained from a user, may be obtained from a data source, and/or may be dynamically determined or combination thereof. A property valuation parameter may be classified according to a property identifier at an operation 1704. A set of market data information may be selected based at least in part upon the property valuation parameter at an operation 1706. At an operation 1708, a valuation model may be selected. The selected valuation model may be applied to the property information to determine a valuation at an operation 1710. One or more dynamic weighting values may be selectively applied to one or more valuation models at an operation 1712. The one or more dynamic weighting values may be obtained from a user, may be obtained from a data source, and/or may be dynamically determined or combination thereof. At an operation 1714, a valuation form may be generated, for example in the form of a property overview 1000 or portion thereof.

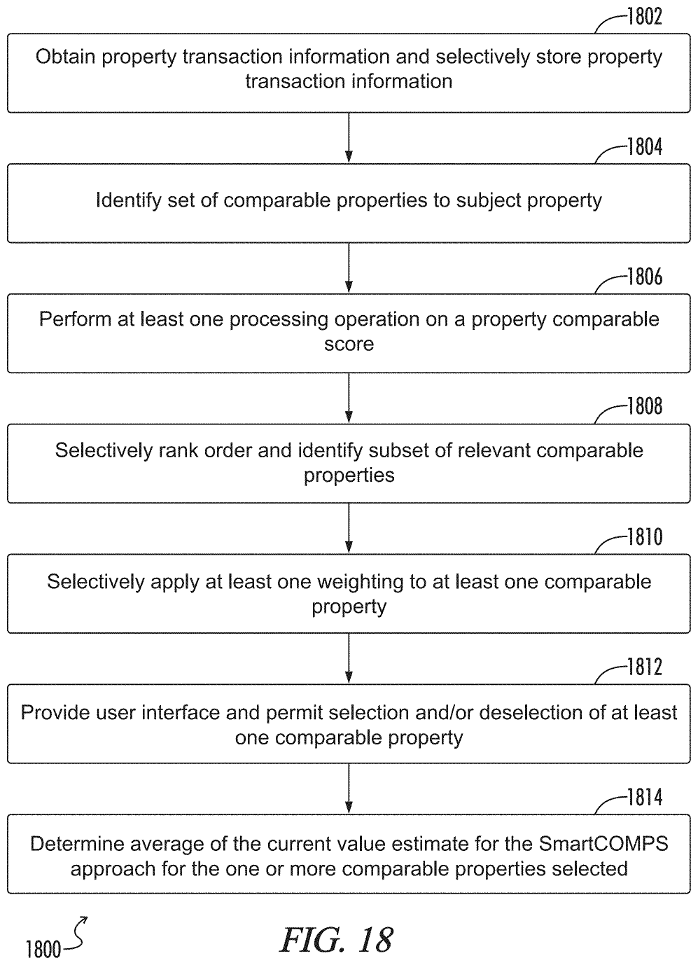

FIG. 18 illustrates an exemplary embodiment of an assisted comp selection method 1800 according to aspects of the present disclosure. The method 1800 includes obtaining property transaction information and selectively storing property transaction information at an operation 1802. At least one set of comparable properties to a subject property are identified at an operation 1804. This may be performed by a user, automatically by the system, or combination thereof. At least one processing operation may be performed on a property comparable score at an operation 1806. A subset of relevant comparable properties may be selected ranked and/or identified at an operation 1808. At least one weighting may be selectively applied to at least one comparable property at an operation 1810. A user interface may be provided at an operation 1812 which permits selection and/or de-selection of at least one comparable property. An average of a current value estimate for a comparable approach (e.g., a SmartCOMPS approach) may be determined for the one or more comparable properties selected at an operation 1814. The method of FIG. 18 may correspond to one or more interface portions and/or sets of information previously described with reference to FIG. 15.

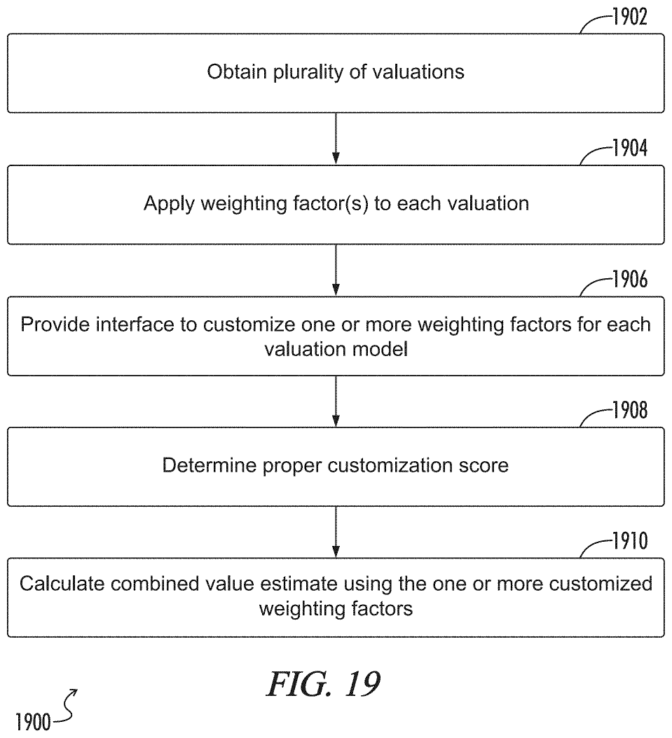

FIG. 19 illustrates an exemplary embodiment of a method 1900 for providing a custom weighted valuation for a property according to aspects of the present disclosure. The method 1900 includes an operation 1902 of obtaining a plurality of valuations. One or more weighting factors may be applied to each valuation at an operation 1904. An interface may be provided to a user at an operation 1906 to customize one or more weighting factors for each valuation model. A proper customization score may be determined at an operation 1908. The proper customization score may include, for example, a value of 100 such that the combination of weights provided to a plurality of valuation models combines to a total value of 100, although any combined value may be used without departing from the spirit and scope of the present disclosure. A combined value estimate may be calculated using the one or more customized weighting factors and selectively presented or otherwise presentable to a user at an operation 1910.

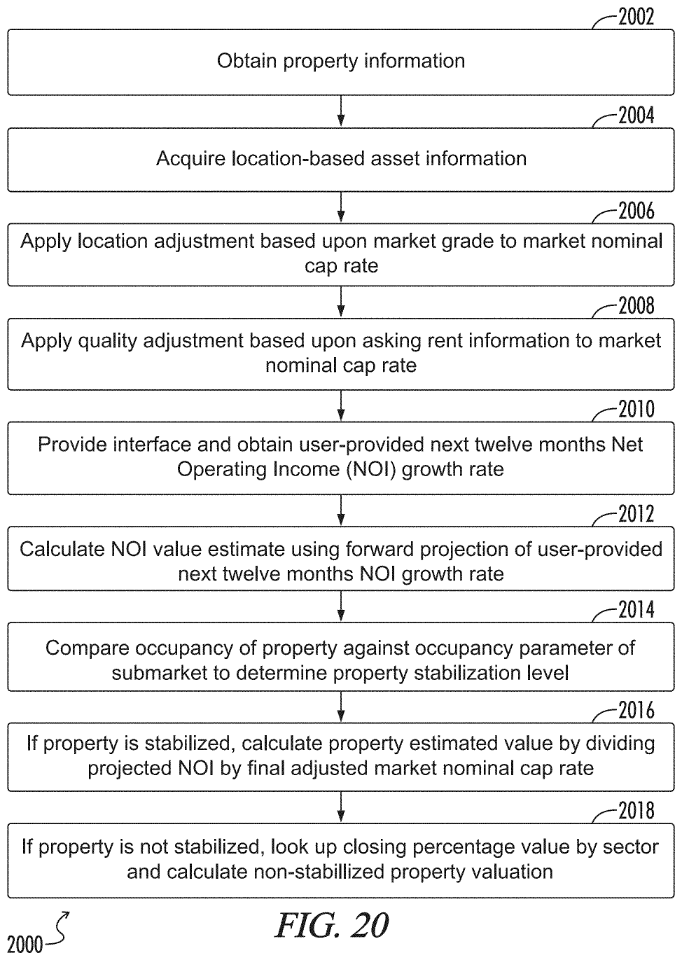

FIG. 20 illustrates an exemplary embodiment of a method 2000 for determining a property valuation according to a stabilization status according to aspects of the present disclosure. The method 2000 may include obtaining property information at an operation 2002. One or more sets of location-based asset information may be acquired at an operation 2004. At least one location adjustment may be applied based upon a market grade to market nominal cap rate at an operation 2006. A quality adjustment may be applied upon asking rent information to market nominal cap rate at an operation 2008. A user interface may be provided at an operation 2010 and a user-provided next twelve months Net Operating Income (NOI) growth rate may be obtained from a user. An NOI value estimate may be calculated using forward projection of the user-provided next twelve months NOI growth rate at an operation 2012. An occupancy of a property against an occupancy parameter of a submarket may be compared at an operation 2014 to determine a property stabilization level. It may be determined at an operation 2016 whether a property is stabilized, and a property estimated value may be calculated by dividing the projected NOI by a final adjusted market nominal cap rate. If a property is determined not to be stabilized, at an operation 2018, a closing percentage value by sector may be looked up and a non-stabilized property valuation may be calculated. Implementations consistent with the method of FIG. 20 may permit an ability to adjust a forward growth rate. In various exemplary embodiments, the system may recommend a growth rate, but a user may be enabled to change the growth rate to any number of their choosing, for example via a provided interface.

Implementations consistent with the present disclosure may be applied to a geographic region or subset thereof. A user may be enabled to self-select one or more comps for a subject property. The system may automatically select one or more relevant comps and a user may be permitted to create their own comp set in various exemplary embodiments. A user may be provided with the ability to adjust weightings applied to one or more valuation models (e.g., NOI valuation, VE valuation, and/or a comparables valuation, or combination thereof). The system may recommend a weighting value for one or more of the models, and a user may be permitted to modify at least one of the weighting values via a user interface. The system may ensure that a total weighting value of the applied valuation models adds to a predetermined number, such as 100. A forward growth rate of associated with a subject property may be adjusted by a user, for example via a user interface. The system may be configured to recommend a growth rate, which may be modifiable by a user via a user interface. A Weighted Average Least Term (WALT) may be incorporated as well as a credit quality value. These may be used to adjust the cap rate based at least in part upon the WALT and/or the average credit quality of one or more tenants. The system may permit the ability to value storage, lodging, senior housing, malls, and other property uses. A loss or gain to lease calculation may be provided. As market rents can often move away from in-place rents due to long leases, an adjustment may be made to the NOI and/or cap rate to reflect such movement.

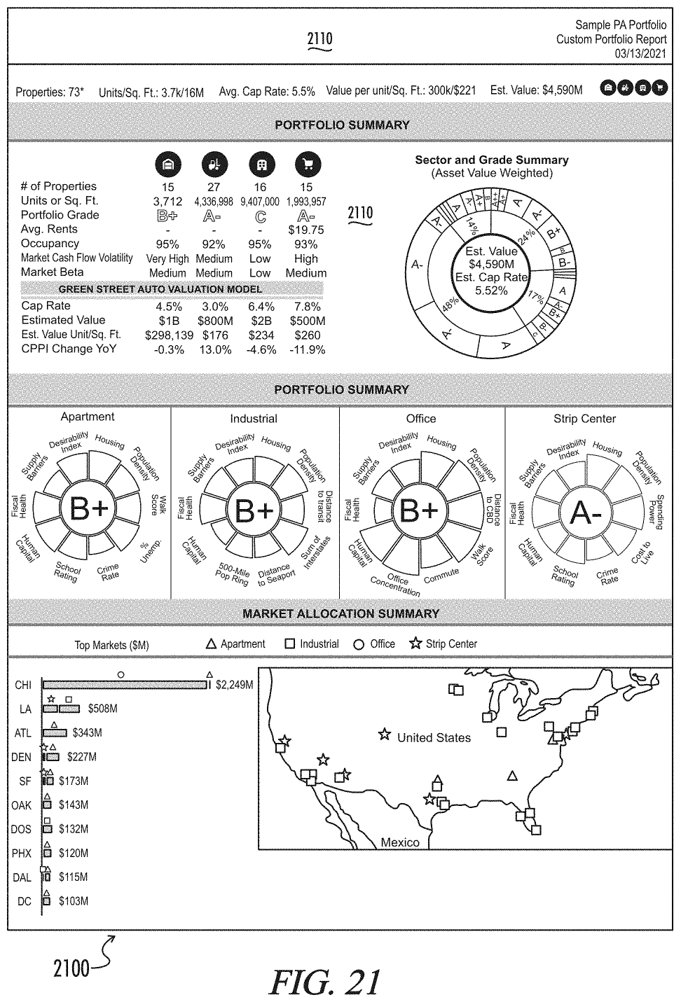

FIG. 21 illustrates an exemplary embodiment of a property portfolio summary 2100 according to aspects of the present disclosure. The property portfolio summary 2100 includes a header section 2110. The header section 2110 may include information including one or more of a number of properties value, a units and square footage value, an average cap rate value, a value per unit and square footage value, and/or an estimated value. A portfolio summary section 2120 may be provided, which conveys information relating to a property portfolio. One or more sets of valuation model information may be provided, and at least one sector and/or grade summary may be presented or otherwise presentable to a user in relation to the portfolio or subset thereof. A portfolio grade section 2130 may be provided in relation to the portfolio or subset thereof. Grades may include one or more categories, such as an apartment grade, an industrial grade, an office grade, a strip center, grade, etc. A market allocation summary section 2140 may be provided to convey a breakdown a portfolio allocation, for example based at least in part upon geographic breakdown and/or property type.

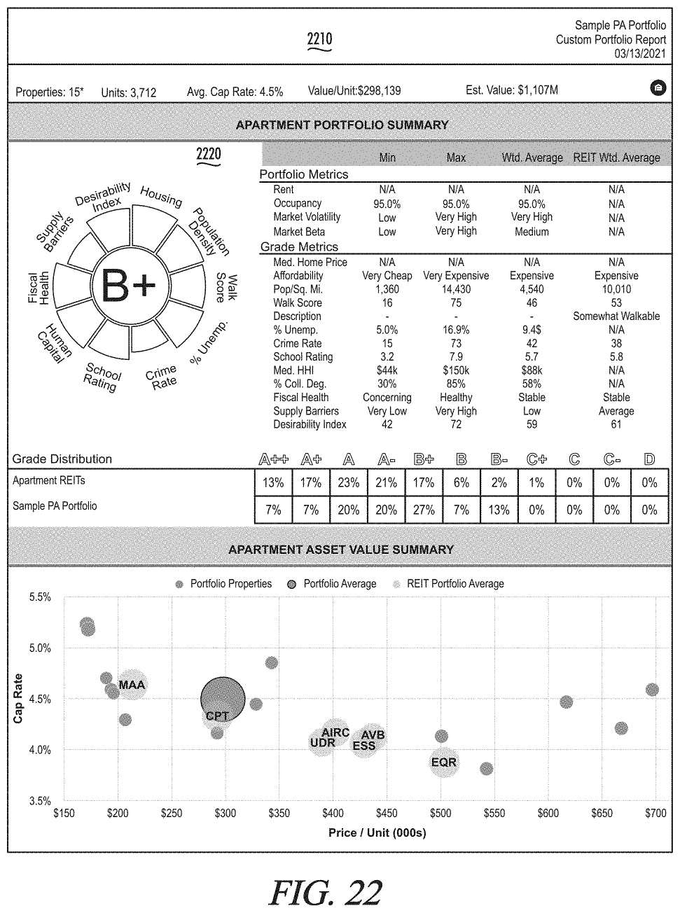

FIG. 22 illustrates an exemplary embodiment of a portfolio subset summary 2000 according to aspects of the present disclosure. The portfolio subset summary 2200 includes a header section 2210 having one or more of a properties value, a units value, an average cap rate value, a value per unit, an estimated value, and/or additional information relating to a subject portfolio or property. A subset portfolio summary section 2220 may be provided, in the example of FIG. 22 in relation to a breakdown of apartments within a subject portfolio. One or more grade and/or breakdowns regarding a subset of the portfolio may be conveyed by the subset portfolio summary section 2220. A grade distribution for a subject portfolio or subset thereof may be provided and may optionally be compared to a benchmark such as an industry standard, alternative portfolio, or other metric. A subset asset value summary 2230 may be provided. The subset asset value summary 2230 may be configured to visually covey at least one metric associated with a subset asset, for example a visual chart, and may include one or more sets of subset information and optionally comparison information to at least one industry standard, alternative portfolio, and/or other metric.

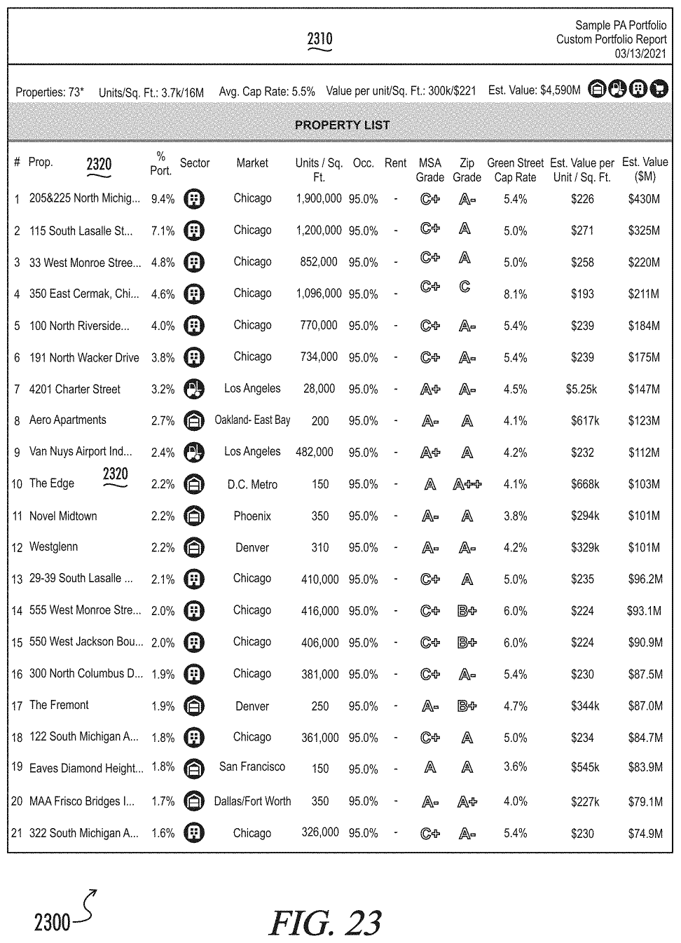

FIG. 23 illustrates an exemplary embodiment of a property list 2300 according to aspects of the present disclosure. The property list 2300 include a header section 2310 including one or more of a properties value, a units per square foot value, an average cap rate value, a value per unit/square footage value, and/or an estimated value. A property list section 2320 may include identification of one or more properties, such as an address, a percentage of each property to an overall portfolio, a market identifier, a units per square footage value, an occupancy rented value, a Metropolitan Statistical Area (MSA) grade, a zip code grade, a cap rate value, an estimated value per unit/square footage value, and/or an estimated value. Additional or alternative information relating to one or more properties may be provided by the property list 2320 without departing from the spirit and scope of the present disclosure. One or more values provided by the property list may include a not rated value.

The apparatuses, systems and methods described herein solve the problems associated with prior commercial property valuation systems by scanning, cleaning, and identifying the most accurate and applicable assets to select as comparable properties. The apparatuses, systems and methods described herein employ a unique market grading algorithm that analyzes up to 50 different location elements to calculate a cap rate that reflects the micro market within where an asset is located. Contrary to common practice in commercial real estate appraisals, which often employ pricing indices based on repeat-sale methodologies that tend to lag real-time pricing by six to twelve months, the apparatuses, systems and methods described herein utilize commercial property price indices that solve for this time lag, which results in more accurate real-time valuations. Green Street's Commercial Property Price Index is a time series of unleveraged U.S. commercial property values that captures the prices at which commercial real estate transactions are currently being negotiated and contracted, as opposed to recently closed sales.

The previous detailed description has been provided for the purposes of illustration and description. Thus, although there have been described particular embodiments of new and useful apparatuses, systems, and methods, it is not intended that such references be construed as limitations upon the scope of this disclosure except as set forth in the following claims.

What is claimed is:

1. A method of providing an Automated Valuation Model (AVM), comprising:
providing a portal coupleable to a network interface;
obtaining a plurality of valuations associated with a subject property via the portal;
receiving at least one weighting factor associated with one or more of the plurality of valuations from a user via the portal;
applying the least one weighting factor to each of the plurality of valuations;
determining a combined value estimate using the weighted plurality of valuations;
generating one or more sets of property information responsive to the combined value estimate; and
transmitting the generated one or more sets of property information via the portal.

2. The method of claim 1, wherein the plurality of valuations includes a Net Operating Income (NOI) valuation, a value extrapolation valuation, and a comparable valuation.

3. The method of claim 1, further comprising:
obtaining a set of property information associated with the subject property via the portal; and
calculating at least one of the obtained plurality of valuations based at least in part upon the obtained set of property information.

4. The method of claim 1, further comprising:
generating at least one overview document for the subject property including information associated with the combined value estimate.

5. The method of claim 1, wherein the applying the at least one weighting factor to each of the plurality of valuations includes comparing a value associated with the at least one weighting factor to a predetermined value.

6. A method of providing an Automated Valuation Model (AVM), comprising:
providing a portal via a network interface;
obtaining a set of property information associated with a subject property via the portal;
calculating a plurality of valuations associated with a subject property based at least in part upon the obtained set of property information;
applying at least one weighting factor to each of the plurality of valuations; and
determining a combined value estimate using the weighted plurality of valuations.

7. The method of claim 6, wherein the plurality of valuations includes a Net Operating Income (NOI) valuation, a value extrapolation valuation, and a comparable valuation.

8. The method of claim 6, further comprising:
generating at least one overview document for the subject property including information associated with the combined value estimate.

9. The method of claim 6, wherein the applying the at least one weighting factor to each of the plurality of valuations includes comparing a value associated with the at least one weighting factor to a predetermined value.

10. A system for providing an Automated Valuation Model (AVM), comprising:
a network;
a user device communicatively coupleable to the network and configured to transmit a set of property information via the network; and
a computing device having a communication section communicatively coupleable to the network and configured to receive the set of property information via the network, the computing device configured to calculate a plurality of valuations associated with a subject property based at least in part upon the set of property information, and to determine a combined value estimate associated with the subject property.

11. The system of claim 10, wherein the computing device includes a weighting section configured to apply at least one weighting factor to each of the plurality of valuations to create a corresponding weighted plurality of valuations associated with the subject property, wherein the combined value estimate is determined using the weighted plurality of valuations associated with the subject property.

12. The system of claim 10, wherein the plurality of valuations includes a Net Operating Income (NOI) valuation, a value extrapolation valuation, and a comparable valuation.

13. The system of claim 10, wherein the computing device includes a generation section configured to generate at least one overview document for the subject property including information associated with the combined value estimate.

14. The system of claim 11, wherein the computing device is configured to compare a value associated with the at least one weighting factor to a predetermined value.

15. The system of claim 11, wherein the computing device is configured to provide a suggested value associated with one or more of the at least one weighting factors.
